(19) United States
(12) Patent Application Publication
(10) Pub. No.: US 2010/0165395 A1
(43) Pub. Date: Jul. 1, 2010

(54) IMAGE PROCESSING APPARATUS, IMAGE PROCESSING SYSTEM, AND CONTROL METHOD FOR IMAGE PROCESSING APPARATUS

(75) Inventor: Mitsugu Yamauchi, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/645,673

(22) Filed: Dec. 23, 2009

(30) Foreign Application Priority Data
Dec. 27, 2008 (JP) 2008-335390

(51) Int. Cl. G06F 15/00; G06K 9/36

(52) U.S. Cl. 358/1.15; 382/232

(57) ABSTRACT

An image processing apparatus that enables to keep its state in a power saving mode by transmitting image data stored in a storage unit to another image processing apparatus even after entering the state of the power saving mode. A conversion unit converts the image data in a first data format stored in the storage unit into image data in a second data format. A transmission unit transmits both the image data in the first data format and the image data in the second data format that is generated by converting the image data in the first data format by the conversion unit to another image processing apparatus connected via a network, when shifting to a power saving mode. A control unit controls to shift to the power saving mode after transmitting both the image data in the first data format and the image data in the second data format.

### BACKGROUND OF THE INVENTION

1. Field of the Invention

The present invention relates to an image processing apparatus, an image processing system, and a control method for the image processing apparatus.

2. Description of the Related Art

A multifunctional image processing apparatus (a multifunction printer; an MFP) that has functions of a copier, a facsimile, and a printer stores a copy image, a facsimile reception image, and a print image sent from a personal computer (a PC) in a memory of the MFP. A user can send a desired image with an electronic mail and print it using the copy image and the print image stored in the memory of the MFP.

In recent years, as increasing performance of the MFP, it is considered that an image is stored in a vector format that is different from a conventional bitmap format in order to increase quality of the stored image, reduce quantity of the image data, and eliminate resolution dependence. Hereafter, an MFP corresponding to the vector format is called a vector-format-capable MFP. An MFP corresponding to the conventional bitmap format is called a bitmap-format-capable MFP.

It should be noted that the vector-format-capable MFP and the bitmap-format-capable MFP may be intermingled on a network. It should be noted that the bitmap-format-capable MFP cannot process a vector format image. On the other hand, the vector-format-capable MFP is developed so as to be able to process both the bitmap format image and the vector format image in order to maintain compatibility with the vector format image in general.

When the bitmap-format-capable MFP processes an image stored in the vector format, it is necessary to convert the vector format image into the bitmap format image. The conversion should be performed by the vector-format-capable MFP.

As a general format conversion technique, there is a technique that determines a format that can be processed by an MFP as a transmission destination of an image, converts the image into the determined format, and then transmits the image in the converted format, i.e., the image that can be processed by the MFP as the transmission destination (see Japanese laid-open patent publication (Kokai) No. 2007-104717 (JP2007-104717A)).

For example, when a user operates an operation panel that is provided on the bitmap-format-capable MFP, a thumbnail of an image that is stored in another MFP on the network may be displayed on a screen of the operation panel (referred to as a thumbnail browsing, hereafter). In such a case, since the MFP to which the user performs the thumbnail browsing operation is the bitmap-format-capable MFP, each MFP in the network needs to transmit the thumbnail image in the bitmap format to the MFP to which the thumbnail browsing operation is performed.

With the above-mentioned conventional technique, when the MFP that receives a request to transmit the thumbnail image is the vector-format-capable MFP, the vector-format-capable MFP concerned converts the thumbnail image stored in the vector format into the bitmap format. Then, the thumbnail image converted into the bitmap format is transmitted to the bitmap-format-capable MFP that requests to transmit the thumbnail image.

On the other hand, an MFP shifts to a power saving mode, when it is not performing a copy operation, a facsimile operation, or a print operation, in general. When the MFP shifts to the power saving mode, an electric power is supplied to necessary minimum sections only, and is not supplied to the other sections, in general.

Since a section that controls an operation to convert the thumbnail image stored in the vector format into the bitmap format has large power consumption under an operating condition, an electric power is not supplied to the section in the power saving mode in most cases. That is, the thumbnail image stored in the vector format cannot be converted into the bitmap format in the power saving mode, and the MFP must return to a normal operation mode from the power saving mode in order to perform the above-mentioned conversion.

As described above, when the vector-format-capable MFP and the bitmap-format-capable MFP are intermingled on the same network, the following problems arise.

When the bitmap-format-capable MFP needs to process an image stored in the vector format (in the case like the above-mentioned thumbnail browsing), another vector-format-capable MFP needs to convert the vector format image into the bitmap format. In such a case, when the other vector-format-capable MFP is in the power saving mode, the other vector-format-capable MFP must return to the normal operation mode from the power saving mode to perform the above-mentioned conversion. This increases the power consumption of the vector-format-capable MFP.

It can be also considered that the vector-format-capable MFP performs the above-mentioned conversion before shifting to the power saving mode, transmits the bitmap format image to another MFP in the normal operation mode, and stores the bitmap format image in the MFP in the normal operation mode.

However, since the image is stored in the bitmap format rather than the vector format, in this method, it loses advantages of the vector format such as an increased quality of the stored image, a reduced quantity of the image data, and an elimination of the resolution dependence.

For example, when the vector-format-capable MFP transmits its storing image data to the bitmap-format-capable MFP in the normal operation mode at a time of shifting to the power saving mode, the vector-format-capable MFP converts the vector format image into the bitmap format and then transmits the converted image.

However, when the bitmap-format-capable MFP concerned shifts to the power saving mode and transmits image data to another apparatus, only image data in the bitmap format is transmitted, even if the other apparatus concerned is the vector-format-capable MFP. Accordingly, the other apparatus concerned loses the advantages of the vector format such as the increased quality of the stored image, the reduced quantity of the image data, and the elimination of the resolution dependence.

### SUMMARY OF THE INVENTION

The present invention provides an image processing apparatus, an image processing system, and a control method for the image processing apparatus that are capable of keeping the image processing apparatus in a power saving mode by transmitting image data stored in the image processing apparatus to another image processing apparatus even after entering the state of the power saving mode. Further, the present invention enables to transmit image data stored in the image processing apparatus in a first data format to the other image processing apparatus after converting the image data into a second data format, even if the other image processing apparatus can handle image data in the second data format but cannot handle image data in the first data format.

Accordingly, a first aspect of the present invention provides an image processing apparatus comprising a storage unit adapted to store image data in a first data format, a conversion unit adapted to convert the image data in the first data format stored in the storage unit into image data in a second data format, a transmission unit adapted to transmit both the image data in the first data format stored in the storage unit and the image data in the second data format that is generated by converting the image data in the first data format by the conversion unit to at least one of other image processing apparatus connected via a network, when shifting to a power saving mode, and a control unit adapted to control to shift to the power saving mode after the transmission unit transmits both the image data in the first data format and the image data in the second data format.

Accordingly, a second aspect of the present invention provides an image processing system that includes an image processing apparatus and other image processing apparatuses connected to the image processing apparatus via a network, the image processing system comprising the image processing apparatus, comprising a first storage unit that stores image data in a first data forma, a conversion unit that converts the image data in the first data format stored in the first storage unit into image data in a second data format, a first transmission unit that transmits both the image data in the first data format stored in the first storage unit and the image data in the second data format that is generated by converting the image data in the first data format by the conversion unit to at least one of the other image processing apparatuses connected via a network, when shifting to a power saving mode, and a control unit that controls to shift to the power saving mode after the first transmission unit transmits both the image data in the first data format and the image data in the second data format, and each of the other image processing apparatuses, comprising a receiving unit that receives both the image data in the first data format and the image data in the second data format transmitted by the first transmission unit.

Accordingly, a third aspect of the present invention provides a control method for an image processing apparatus comprising a conversion step of converting image data in a first data format stored in a storage unit provided on the image processing apparatus into image data in a second data format, a transmission step of transmitting both the image data in the first data format and the image data in the second data format that is generated by converting the image data in the first data format to at least one of other image processing apparatuses connected via a network, when shifting to a power saving mode, and a control step of controlling the image processing apparatus to shift to a power saving mode after transmitting both the image data in the first data format and the image data in the second data format in the transmission step.

According to the present invention, the image processing apparatus can be kept in the power saving mode by transmitting image data stored in the image processing apparatus to another image processing apparatus even after entering the state of the power saving mode. Further, the image data stored in the image processing apparatus in the first data format can be transmitted to the other image processing apparatus after the image data is converted into the second data format, even if the other image processing apparatus can handle image data in the second data format but cannot handle image data in the first data format.

Further features of the present invention will become apparent from the following description of exemplary embodiments with reference to the attached drawings.

### BRIEF DESCRIPTION OF THE DRAWINGS

FIG. 1 is a view schematically showing a configuration of an image processing apparatus according to a first embodiment of the present invention.

FIG. 2 is a view showing a power supply state of each unit of the image processing apparatus of the present invention.

FIG. 3 is a view schematically showing configurations of the image processing apparatus and an image processing system according to the first embodiment of the present invention.

FIG. 4 is a flowchart showing an example of an image vectorization process according to the first embodiment.

FIG. 5 is a view showing an example of a data structure of a vector format image acquired by the image vectorization process shown in FIG. 4.

FIG. 6 is a view showing an example of data stored in a plurality of hard disks shown in FIG. 3.

FIG. 7 is a flowchart showing an operation (a first control operation) of a vector-format-capable apparatus when shifting to a power saving mode, in the image processing apparatus and the image processing system according to the first embodiment of the present invention.

FIG. 8 is a view showing an example of information acquired by the vector-format-capable apparatus.

FIG. 9 is a view showing conditions of the data in the plurality of hard disks after a predetermined operation.

FIG. 10 is a view showing an example of information acquired by the vector-format-capable apparatus.

FIG. 11 is a view showing conditions of the data in the plurality of hard disks after a predetermined operation.

FIG. 12 is a flowchart showing an operation (a second control operation) of a bitmap-format-capable apparatus after a predetermined operation.

FIG. 13 is a view showing conditions of the data in the plurality of hard disks after a predetermined operation.

FIG. 14 is a flowchart showing an operation when displaying a vector format thumbnail on a screen of an operation panel of the vector-format-capable apparatus.

FIG. 15 is a view schematically showing configurations of an image processing apparatus and an image processing system according to a second embodiment of the present invention.

FIG. 16 is a view showing data stored in a plurality of hard disks shown in FIG. 15.

FIG. 17 is a flowchart showing an operation when the vector-format-capable apparatus shifts to the power saving mode in the image processing apparatus and the image processing system according to the second embodiment of the present invention.

FIG. 18 is a view showing conditions of the data stored in the plurality of hard disks after shifting to the power saving mode.

FIG. 19 is a view schematically showing configurations of an image processing apparatus and an image processing system according to a third embodiment of the present invention.

FIG. 20 is a view showing conditions of data in the plurality of hard disks after the vector-format-capable apparatus has shifted to the power saving mode according to the third embodiment.

### DESCRIPTION OF THE EMBODIMENTS

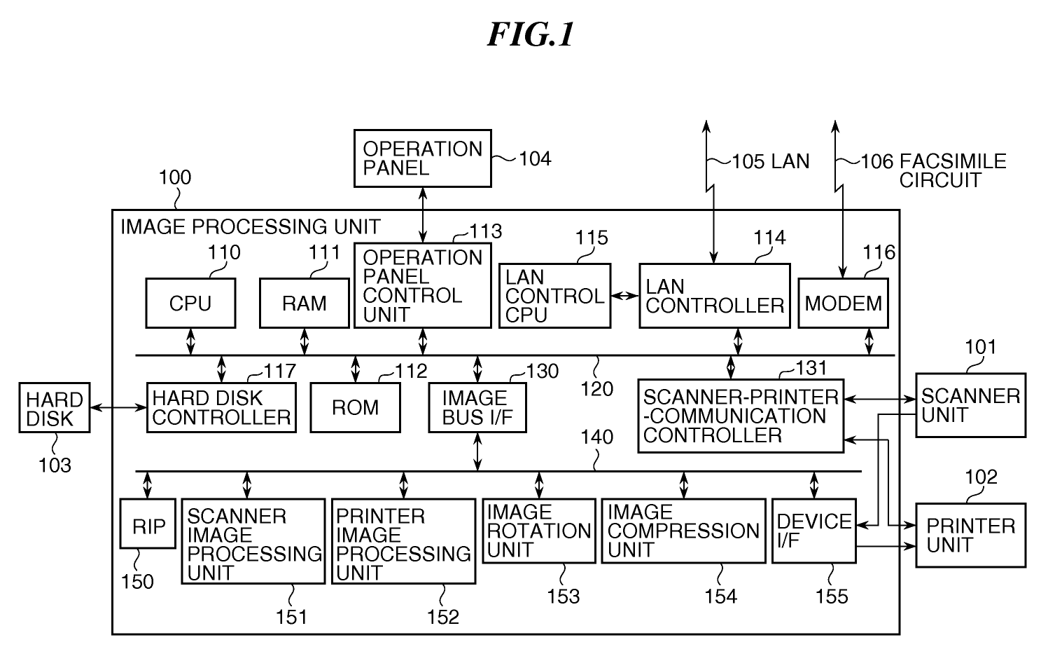

FIG. 1 is a view schematically showing a configuration of an image processing apparatus according to a first embodiment of the present invention.

As shown in FIG. 1, the image processing apparatus of the present invention comprises an image processing unit 100, a scanner unit 101 that is an image input device, a printer unit 102 that is an image output device, and a hard disk 103 that is a data storage medium, etc.

The image processing unit 100 is connected to the scanner unit 101, the printer unit 102, and the hard disk 103.

The image processing unit 100 is connected to a LAN (a Local Area Network) 105 and a facsimile circuit 106, and can transmit/receive data to/from an external apparatus through the LAN 105 or the facsimile circuit 106 (communication is possible).

The hard disk 103 stores system software, image data, software counter values, etc. A reference numeral 104 denotes an operation panel of the image processing apparatus concerned, and has various button switches, a LCD touch panel, etc. (not shown in a figure). A user performs various operations to the image processing apparatus using the operation panel 104.

A reference numeral 110 denotes a CPU that controls the entire system behavior of the image processing unit 100. A RAM 111 is a system work memory for an operation of the CPU 110, and is also an image memory for storing image data temporarily. A ROM 112 is a boot ROM that stores a boot program of the system.

An operation panel control unit 113 is a section that controls an interface with the operation panel 104. The operation panel control unit 113 outputs image data to be displayed on the operation panel 104 to the operation panel 104. The operation panel control unit 113 gives information that the user inputted using the operation panel 104 to the CPU 110.

A LAN controller 114 is connected to the LAN 105, and inputs and outputs data. A LAN control CPU 115 is connected to the LAN controller 114. The LAN control CPU 115 controls an I/O (Input/Output) of data in the LAN controller 114.

A modem 116 is connected to the facsimile circuit 106 and transmits and receives facsimile data. A hard disk controller 117 is connected to the hard disk 103 and controls an I/O of data of the hard disk 103. A scanner-printer-communication controller 131 controls communications with the scanner unit 101 and the printer unit 102.

The above-mentioned units 110 through 117, and 131 are arranged on a system bus 120.

An image bus I/F 130 is a bus bridge that connects the system bus 120 with an image bus 140 that transmits image data at high speed, and converts a data structure. The image bus 140 comprises a PCI bus or an IEEE1394. The following units are arranged on the image bus 140.

A raster image processor (RIP) 150 develops a PDL code into a bitmap image. A scanner image processing unit 151 performs a correction, a processing, and an editing with respect to inputted image data. A printer image processing unit 152 performs a correction of a printer, a conversion of resolution, or the like with respect to print-output image data.

An image rotation unit 153 rotates image data. An image compression unit 154 performs a JPEG compression/extension process to multi value image data, and a JBIG, MMR, or MH compression/extension process to binary image data. A device I/F unit 155 connects the image processing unit 100 with the image I/O devices such as the scanner unit 101 and the printer unit 102, and converts image data in a synchronous fashion or an asynchronous fashion.

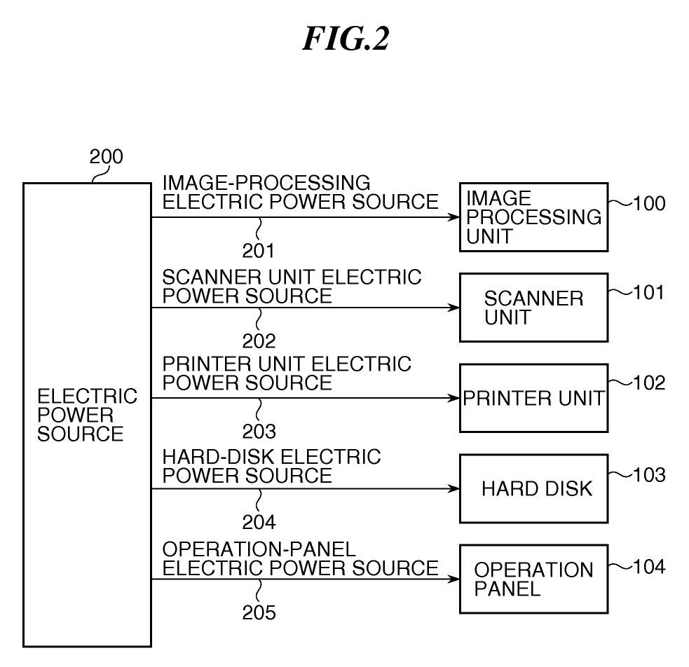

FIG. 2 is a view showing a power supply state of each unit of the image processing apparatus of the present invention.

As shown in FIG. 2, electric power is supplied to the image processing unit 100, the scanner unit 101, the printer unit 102, the hard disk 103, and the operation panel 104 from an electric power source 200 that is included in the image processing apparatus.

The electric power is supplied to the image processing unit 100 from the electric power source 200 through an image-processing electric power source 201. Supplying/interrupting of the electric power to the image processing unit 100 can be controlled by instructing supplying/interrupting of the electric power to the image-processing electric power source 201.

Similarly, supplying/interrupting of the electric power to the scanner unit 101, the printer unit 102, the hard disk 103, and the operation panel 104 from the electric power source 200 can be controlled through a scanner unit electric power source 202, a printer unit electric power source 203, a hard-disk electric power source 204, and an operation-panel electric power source 205, respectively.

As mentioned above, the user can interrupt the electric power by operating the operation panel 104, but the image processing unit 100 can detect an operation of a predetermined switch key with which the operation panel 104 is provided, even if the electric power is interrupted by the user.

The image processing apparatus has two operation modes including a power saving mode and a normal operation mode that is a condition where the electric power is not saved.

In the normal operation mode, electric power is supplied to all the units in FIG. 2, and all the functions of the image processing apparatus can be executed.

On the other hand, in the power saving mode, the electric power to the scanner unit 101, the printer unit 102, the hard disk 103, and the operation panel 104 in FIG. 2 is interrupted. It should be noted that the electric power is supplied to the image processing unit 100 through the image-processing power source 201 even in the power saving mode.

The image processing unit 100 performs a more detailed electric power control and thus can control supplying/interrupting of the electric power to each unit inside the image processing unit 100 in FIG. 1. For example, in the power saving mode, the electric power is supplied only to the RAM 111, the LAN controller 114, the LAN control CPU 115, and the modem 116 in the image processing unit 100. However, in the power saving mode, the electric power to the units other than the above-mentioned RAM 111, the LAN controller 114, the LAN control CPU 115, and the modem 116 is interrupted (the electric power to the CPU 110 is also interrupted).

It should be noted that the electric power is supplied to all the units in the image processing unit 100 in FIG. 1 in the normal operation mode.

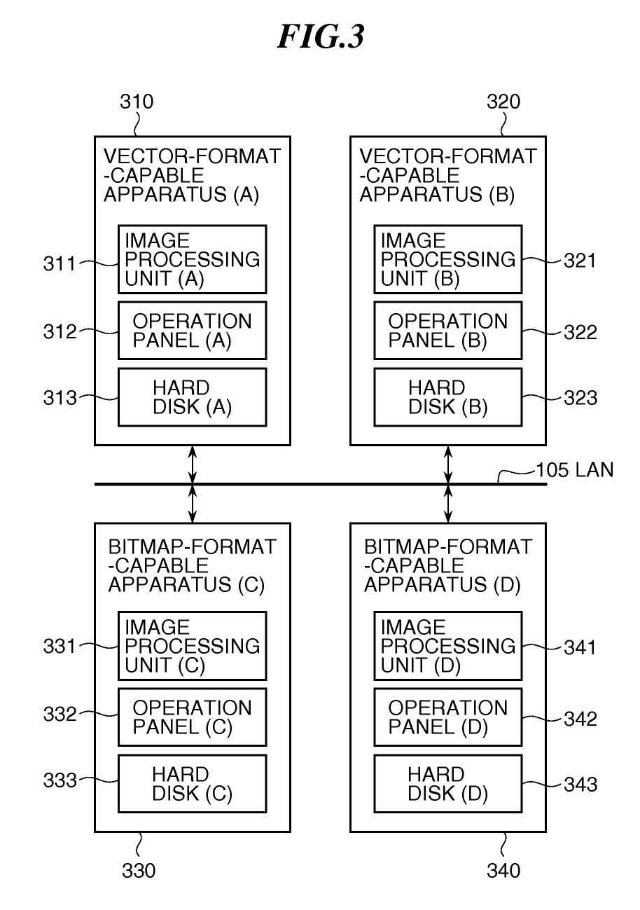

FIG. 3 is a view schematically showing configurations of the image processing apparatus and the image processing system according to the first embodiment of the present invention.

In FIG. 3, a vector-format-capable apparatus (A) 310 is an MFP that has an image processing unit (A) 311, an operation panel (A) 312, and a hard disk (A) 313. The vector format is a first data format.

Although the vector-format-capable apparatus (A) 310 is the MFP that has the configuration shown in FIG. 1, FIG. 3 shows only the image processing unit (A) 311, the operation panel (A) 312, and the hard disk (A) 313 for description. It should be noted that the image processing unit (A) 311, the operation panel (A) 312, and the hard disk (A) 313 are equivalent to the image processing unit 100, the operation panel 104, and the hard disk 103 in FIG. 1, respectively.

The vector-format-capable apparatus (A) 310 stores a copy image, a facsimile reception image, and a print image from a PC into the hard disk (A) 313 of the vector-format-capable apparatus (A) 310 in the vector format.

A vector-format-capable apparatus (B) 320 is an MFP that has an image processing unit (B) 321, an operation panel (B) 322, and a hard disk (B) 323. The vector-format-capable apparatus (B) 320 stores the various types of images into the hard disk (B) 323 in the vector format like the vector-format-capable apparatus (A) 310.

A bitmap-format-capable apparatus (C) 330 is an MFP that has an image processing unit (C) 331, an operation panel (C) 332, and a hard disk (C) 333. The bitmap format is a second data format. Although the bitmap-format-capable apparatus (C) 330 is the MFP that has the configuration shown in FIG. 1, FIG. 3 shows only the image processing unit (C) 331, the operation panel (C) 332, and the hard disk (C) 333 for description. It should be noted that the image processing unit (C) 331, the operation panel (C) 332, and the hard disk (C) 333 are equivalent to the image processing unit 100, the operation panel 104, and the hard disk 103 in FIG. 1, respectively.

The bitmap-format-capable apparatus (C) 330 stores a copy image, a facsimile reception image, and a print image from a PC into the hard disk (C) 333 of the bitmap-format-capable apparatus (C) 330 in the bitmap format that is different from the vector format.

A bitmap-format-capable apparatus (D) 340 is an MFP that has an image processing unit (D) 341, an operation panel (D) 342, and a hard disk (D) 343. The bitmap-format-capable apparatus (D) 340 stores the various types of images into the hard disk (D) 343 in the bitmap format like the bitmap-format-capable apparatus (C) 330.

The vector-format-capable apparatus (A) 310, the vector-format-capable apparatus (B) 320, the bitmap-format-capable apparatus (C) 330, and the bitmap-format-capable apparatus (D) 340 are connected to the LAN 105. In addition to the apparatuses, a PC, a server, etc. are connected to the LAN 105, but they are not shown in FIG. 3.

The image processing unit (A) 311 of the vector-format-capable apparatus (A) 310 and the image processing unit (B) 321 of the vector-format-capable apparatus (B) 320 can perform not only the image processing in the vector format but also predetermined processing in the bitmap format. Specifically, the predetermined processing includes a vector-format image processing, a conversion process of a vector format image into the bitmap format (the conversion process to the bitmap format), etc. It should be noted that the vector-format image processing and the conversion process to the bitmap format are executed by the RIP unit 150 based on an instruction from the CPU 110, which operates according to a program stored in the ROM 112, in FIG. 1.

It should be noted that the electric power to the CPU 110 and the RIP unit 150 is interrupted in the power saving mode as described above. Accordingly, the vector-format-capable apparatus (A) 310 and the vector-format-capable apparatus (B) 320 cannot perform the vector-format image processing or the conversion process to the bitmap format in the power saving mode.

The image processing unit (C) 331 of the bitmap-format-capable apparatus (C) 330 and the image processing unit (D) 341 of the bitmap-format-capable apparatus (D) 340 can perform the image processing in the bitmap format only, and cannot perform the image processing in the vector format (the vector format processing is impossible).

The bitmap-format image processing is executed by the RIP unit 150 based on an instruction from the CPU 110, which operates according to a program stored in the ROM 112, in FIG. 1. It should be noted that the electric power to the CPU 110 and the RIP unit 150 is interrupted in the power saving mode as described above. Accordingly, the bitmap-format-capable apparatus (C) 330 and the bitmap-format-capable apparatus (D) 340 cannot perform the bitmap-format image processing in the power saving mode.

Here, the bitmap format and the vector format will be described.

The bitmap format defines an image as an aggregation of pixels. A pixel has a size. Therefore, an image quality in the bitmap format is dependent on a resolution of an image. When a processing such as a zooming is performed to an optimal (high-quality) image at a predetermined resolution, deterioration of the image such as jaggies generates.

On the other hand, the vector format defines an image by points, lines, and polygons rather than the aggregation of pixels. A line is defined by two points and a polygon is defined by two or more lines. Therefore, all images will be defined by points. A point does not have an area (a size). Since an image is defined by such points, zooming of the image does not generate jaggies, which enables to obtain a high-quality image without depending on the resolution.

The higher the resolution of the image is, the larger the data quantity of the bitmap format image is. On the other hand, the vector format enables to define a high-resolution image with a data quantity that is smaller than that in the bitmap format.

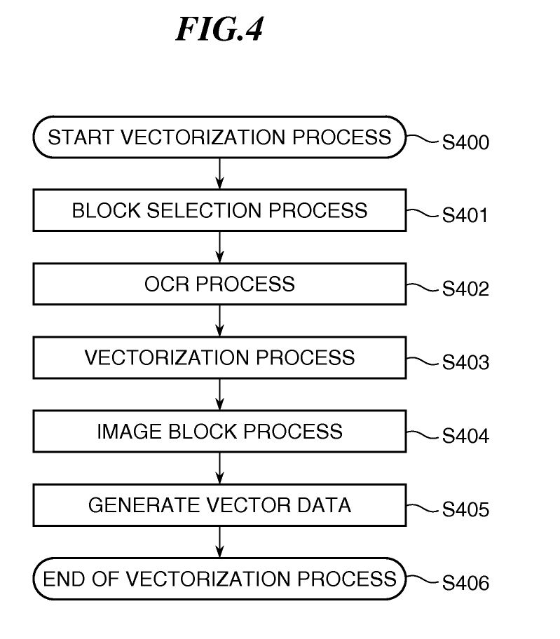

FIG. 4 is a flowchart showing an example of an image vectorization process according to the first embodiment. The process is executed by the image processing unit (A) 311 and the image processing unit (B) 321 shown in FIG. 3.

First, in step S401, the image processing unit performs a block selection process to a processing target image. It should be noted that the block selection process is a process to divide the image into blocks for object groups and to determine attributes of the divided blocks from among a character (TEXT), an image (PHOTO), a line (LINE), a pattern (PICTURE), a table (TABLE), etc.

Then, in the process in steps S402 through S405, the image processing unit performs processes required for vectorization to each of the blocks divided in the process in the above-mentioned step S401. Hereafter, details will be described.

First, in step S402, the image processing unit performs an OCR process to the block determined as the character in the above-mentioned step S401.

And in step S403, the image processing unit recognizes a size, a style, a font, etc. of a character in the character block subjected to the OCR process, and performs the vectorization process to convert the character in the processing target image into font data that is visibly faithful to the character. The image processing unit performs the vectorization processes to the line block, the pattern block, and the table block by taking outlines.

On the other hand, the image processing unit separates the image block as image data to generate a separate JPEG file and performs an image processing in step S404.

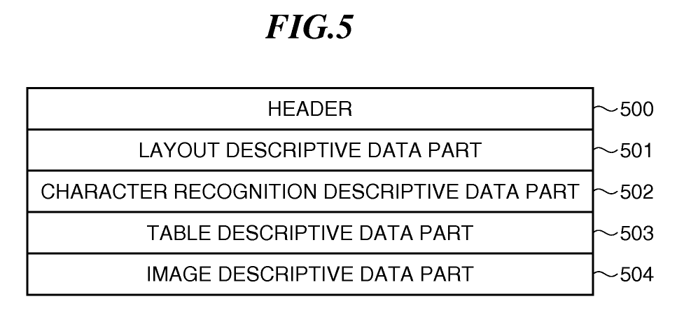

Then, in step S405, the image processing unit summarizes the attribute and position information of each of the blocks divided by the process in the step S401, OCR information, font information, vector information, and image information that are extracted in the process in the steps S402 through S404 in the vector format as shown in FIG. 5 (a creation of vector data). Then, the vectorization process is finished.

FIG. 5 is a view showing an example of a data structure of the vector format image data acquired by the image vectorization process shown in FIG. 4.

In FIG. 5, a header 500 holds information about the processing target image data. A layout descriptive data part 501 holds the attribute information and its rectangle address information of each block that has been recognized for every attribute such as a character, an image, a line, a pattern, a table in the processing target image data.

A character recognition descriptive data part 502 holds a character recognition result (the result of the OCR process in the step S402) obtained by executing a character recognition to the character block. A table descriptive data part 503 stores details of an structure of the table block. An image descriptive data part 504 holds the image data processed as the above-mentioned image data (the image block process in the step S404).

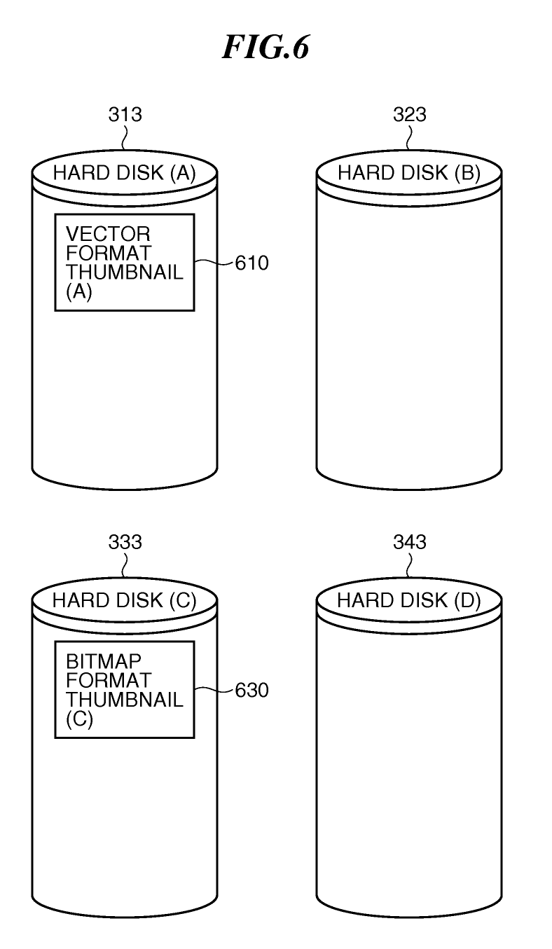

FIG. 6 is a view showing an example of the data stored in the hard disk (A) 313, the hard disk (B) 323, the hard disk (C) 333, and the hard disk (D) 343 shown in FIG. 3.

In FIG. 6, a vector format thumbnail (A) 610 is thumbnail data of the various types of images stored in the hard disk (A) 313. The vector format thumbnail (A) 610 is stored in the vector format that can be processed by the vector-format-capable apparatus (A) 310 and the vector-format-capable apparatus (B) 320.

A bitmap format thumbnail (C) 630 is thumbnail data of the various types of images stored in the hard disk (C) 333. The bitmap format thumbnail (C) 630 is stored in the bitmap format that can be processed by the bitmap-format-capable apparatus (C) 330 and the bitmap-format-capable apparatus (D) 340.

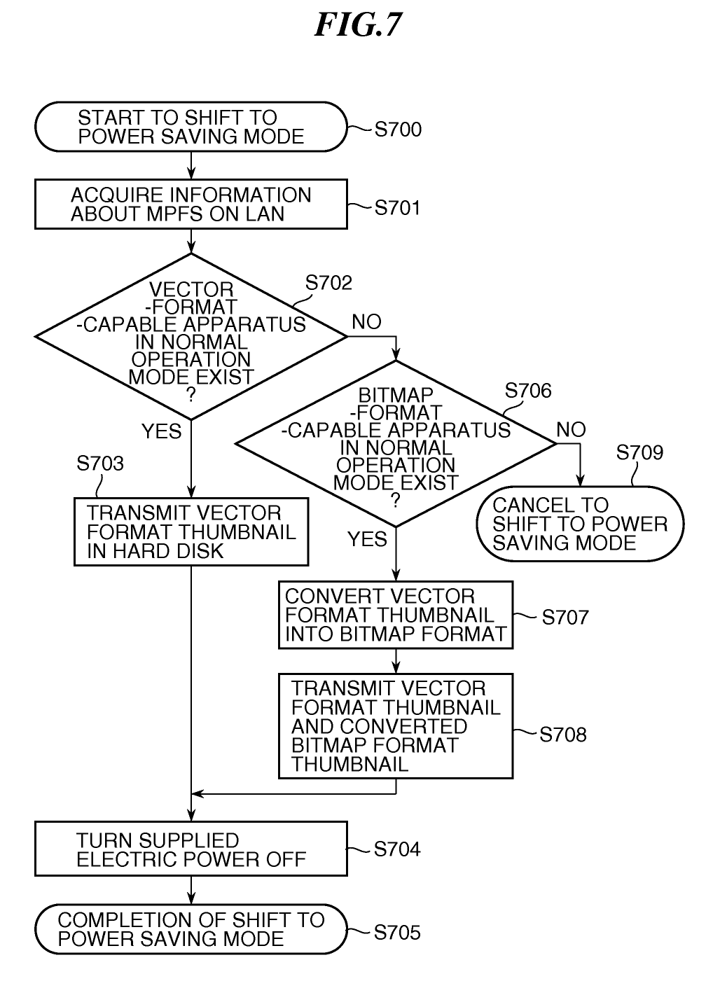

Hereafter, operations of the image processing apparatus and the image processing system according to the first embodiment of the present invention will be described with reference to FIG. 7 through FIG. 14.

FIG. 7 is a flowchart showing an operation (a first control operation) of the vector-format-capable apparatus (A) 310 when shifting to the power saving mode, in the image processing apparatus and the image processing system according to the first embodiment of the present invention. It should be noted that the process of the flowchart in FIG. 7 is performed when the CPU 110 of the vector-format-capable apparatus (A) 310 executes a program stored in the ROM 112. In FIG. 7, steps S700 through S709 show procedures of each operation.

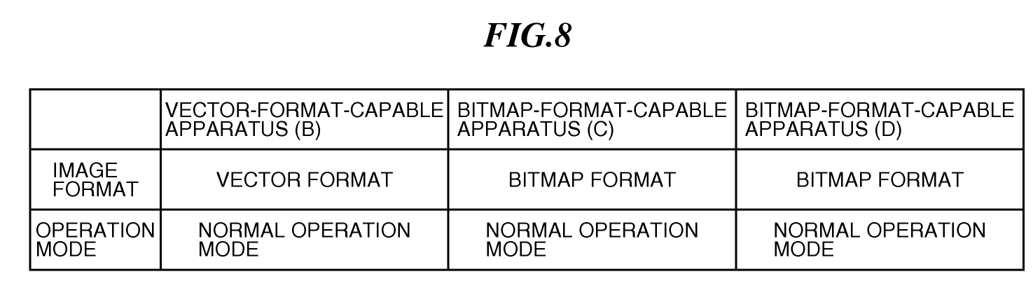

FIG. 8 is a view showing an example of information acquired by the vector-format-capable apparatus (A) 310. Details of the acquired information will be described later.

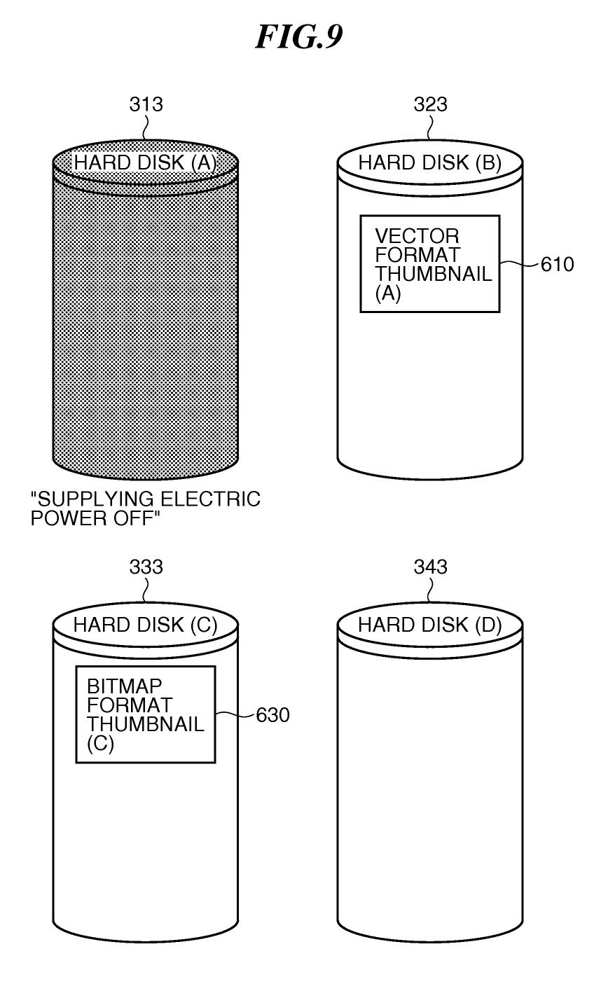

FIG. 9 is a view showing conditions of the data stored in the hard disk (A) 313, the hard disk (B) 323, the hard disk (C) 333, and the hard disk (D) 343 after a predetermined operation. It should be noted that the predetermined operation will be described later.

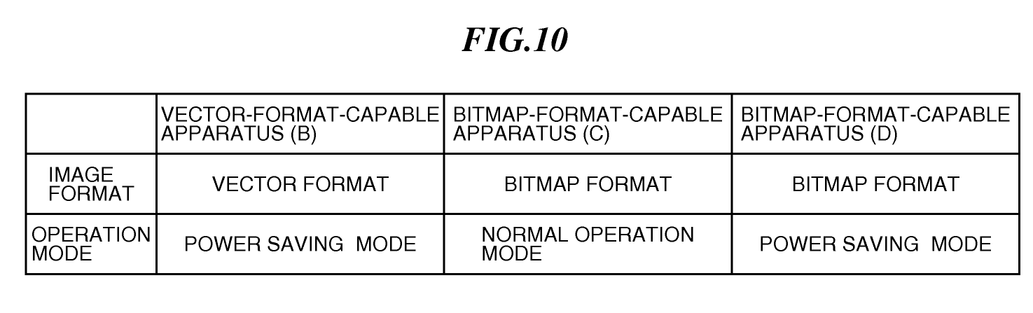

FIG. 10 is a view showing an example of information acquired by the vector-format-capable apparatus (A) 310.

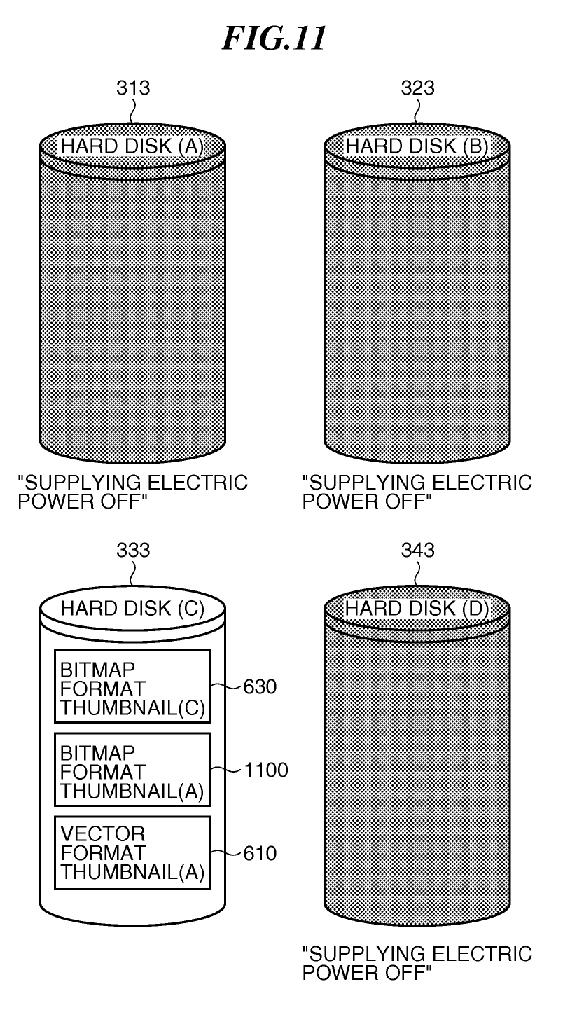

FIG. 11 is a view showing conditions of the data stored in the hard disk (A) 313, the hard disk (B) 323, the hard disk (C) 333, and the hard disk (D) 343 after a predetermined operation. It should be noted that the predetermined operation will be described later.

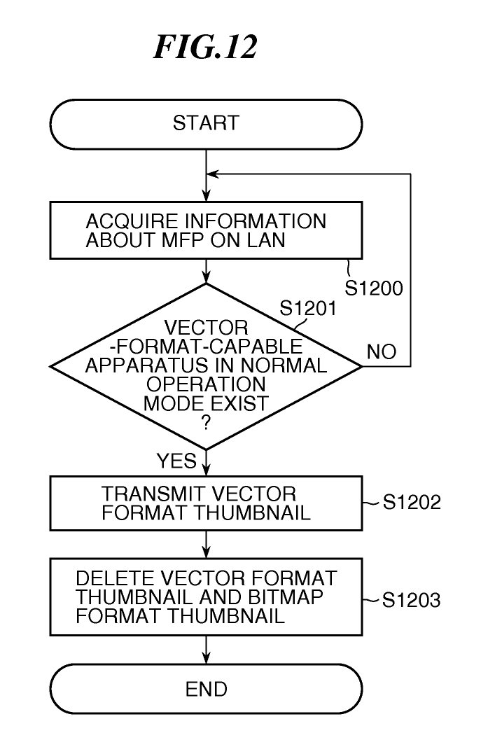

FIG. 12 is a flowchart showing an operation (a second control operation) of the bitmap-format-capable apparatus (C) 330 after a predetermined operation. It should be noted that the process of the flowchart in FIG. 12 is performed when the CPU 110 of the bitmap-format-capable apparatus (C) 330 executes a program stored in the ROM 112. In FIG. 12, steps S1200 through S1203 show procedures of each operation. It should be noted that the predetermined operation will be described later.

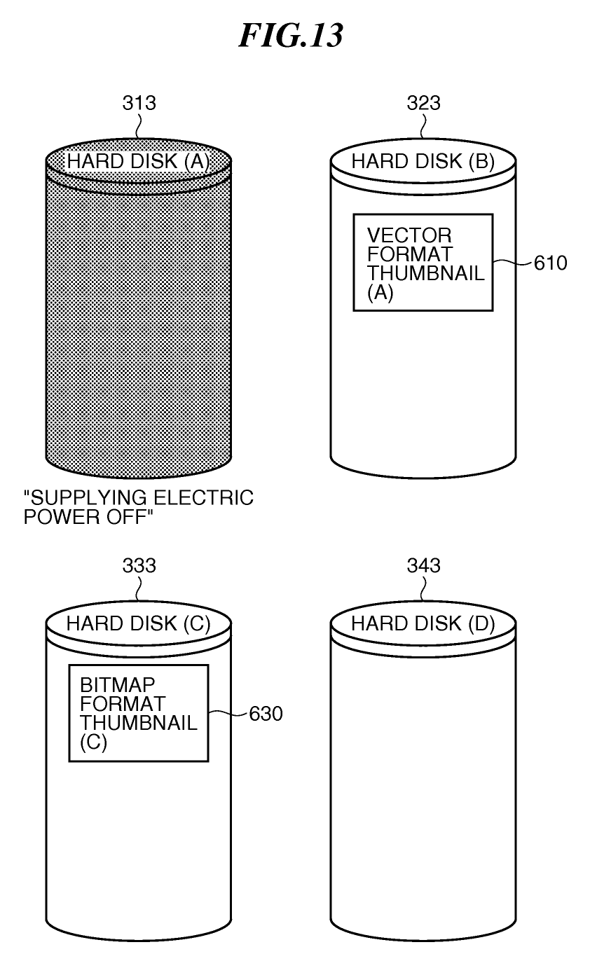

FIG. 13 is a view showing conditions of the data stored in the hard disk (A) 313, the hard disk (B) 323, the hard disk (C) 333, and the hard disk (D) 343 after a predetermined operation. It should be noted that the predetermined operation will be described later.

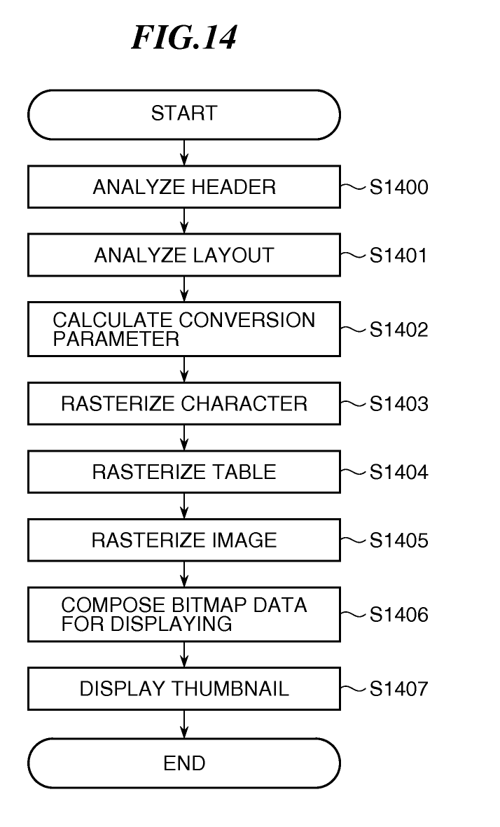

FIG. 14 is a flowchart showing an operation when displaying a vector format thumbnail on a screen of the operation panel (B) 322 of the vector-format-capable apparatus (B) 320. It should be noted that the process of the flowchart in FIG. 14 is performed when the CPU 110 of the vector-format-capable apparatus (B) 320 executes a program stored in the ROM 112. In FIG. 14, steps S1400 through S1407 show procedures of each operation.

First, operations when the vector-format-capable apparatus (A) 310 shifts to the power saving mode (a first acquisition process, a first determination process, a second determination process, a first transmission process, etc.) will be described using FIG. 7 through FIG. 11.

When a predetermined condition to shift to the power saving mode in the vector-format-capable apparatus (A) 310 is ready, the vector-format-capable apparatus (A) 310 starts to shift to the power saving mode (S700 in FIG. 7). Hereafter, the process will be described along the flowchart in FIG. 7.

In step S701, the vector-format-capable apparatus (A) 310 acquires information about the MFPs on the LAN 105 immediately after starting the shift to the power saving mode. Specifically, an image storing format and information whether the mode is the normal operation mode or the power saving mode (electric power condition information) of each MFP connected to the LAN 105 are acquired (the first acquisition process). FIG. 8 is a view showing an example of information acquired by the vector-format-capable apparatus (A) 310. It should be noted that the MFP of which the image storing format is the “vector format” is possible to execute the conversion process from the vector format image data into the bitmap format image data. On the other hand, the MFP of which the image storing format is the “bitmap format” is not possible to execute the conversion process from the vector format image data into the bitmap format image data. That is, the image storing format of each MFP acquired in the step S701 corresponds to conversion information that shows whether the conversion process from the vector format image data into the bitmap format image data can be executed or not.

In step S702 after acquiring the information in the step S701, the vector-format-capable apparatus (A) 310 determines whether a vector-format-capable apparatus (the first image processing apparatus) in the normal operation mode exists on the LAN 105 or not (the first determination process).

When it is determined that a vector-format-capable apparatus in the normal operation mode exists on the LAN 105 in the step S702 (“Y” in the step S702), the vector-format-capable apparatus (A) 310 proceeds with the process to step S703.

In the step S703, the vector-format-capable apparatus (A) 310 transmits the vector format thumbnail in its hard disk to the vector-format-capable apparatus in the normal operation mode.

For example, the information about the MFP on the LAN acquired in the step S701 is assumed that the vector-format-capable apparatus (B) is in the normal operation mode as shown in FIG. 8. In this case, the vector-format-capable apparatus (A) 310 transmits the vector format thumbnail in its hard disk to the vector-format-capable apparatus (B) 320. Specifically, the vector format thumbnail (A) 610 in the hard disk (A) 313 in FIG. 6 is transmitted to the vector-format-capable apparatus (B) 320. The vector-format-capable apparatus (B) 320 stores the received vector format thumbnail (A) 610 into the hard disk (B) 323 (see FIG. 9).

When the process in the step S703 is completed, the image processing unit 100 of the vector-format-capable apparatus (A) 310 controls to turn the electric power supplied to the predetermined sections OFF in step S704. Specifically, the electric power supplied to the scanner unit 101, the printer unit 102, the hard disk 103, and the operation panel 104 in FIG. 2 is interrupted. That is, in FIG. 3, the electric power supplied to the operation panel (A) 312 and the hard disk (A) 313 is interrupted. About the image processing unit 100 in FIG. 2, i.e., the image processing unit (A) 311 in FIG. 3, as mentioned above using FIG. 1, the electric power is supplied to predetermined sections, and the electric power supplied to the other sections is interrupted. That is, the electric power is supplied only to the RAM 111, the LAN controller 114, the LAN control CPU 115, and the modem 116 in FIG. 1, and the electric power supplied to the other section is interrupted.

The vector-format-capable apparatus (A) 310 completes the process to shift to the electric power saving mode (S705 in FIG. 7) after turning the supplying electric power OFF, and enters a state of the electric power saving mode.

As mentioned above, the vector-format-capable apparatus (A) 310 transmits the vector format thumbnail (A) 610 to the vector-format-capable apparatus (B) 320, and also turns the supplying electric power OFF. FIG. 9 is a view showing conditions of the data stored in the hard disk (A) 313, the hard disk (B) 323, the hard disk (C) 333, and the hard disk (D) 343 after turning the supplying electric power OFF. In FIG. 9, the electric power supplied to the hard disk (A) 313 is OFF.

As described above, when it is determined that a vector-format-capable apparatus in the normal operation mode exists in the step S702 in FIG. 7, the vector-format-capable apparatus (A) 310 stores the vector format thumbnail (A) 610 in the hard disk (A) 313 into the hard disk (B) 323 of the vector-format-capable apparatus (B) 320, and then shifts to the power saving mode.

Hereafter, a case where it is determined that a vector-format-capable apparatus in the normal operation mode does not exist on the LAN 105 (“N” in step S702) in the determination whether a vector-format-capable apparatus in the normal operation mode exists on the LAN 105 as shown in the step S702 in FIG. 7 will be described.

In this case, the vector-format-capable apparatus (A) 310 determines whether a bitmap-format-capable apparatus (a second image processing apparatus) in the normal operation mode exists on the LAN 105 or not (the second determination process) in step S706 based on the information acquired in the step S701.

First, a case where it is determined that a bitmap-format-capable apparatus in the normal operation mode exists (“Y” in the step S706) in the determination in the step S706 in FIG. 7 will be described. An example when information-acquisition results of the MFPs on the LAN in the step S701 in FIG. 7 correspond to the conditions shown in FIG. 10 will be described.

In this case, the vector-format-capable apparatus (A) 310 converts the vector format thumbnail (A) 610 in the hard disk (A) 313 in FIG. 6 into the bitmap format in step S707. Specifically, the vector format thumbnail (A) 610 is converted into the bitmap format by the image processing unit (A) 311 shown in FIG. 3. It should be noted that the data that is obtained by converting the vector format thumbnail (A) 610 into the bitmap format is referred to as a bitmap format thumbnail (A) for purpose of explanation.

Then, in step S708, the vector-format-capable apparatus (A) 310 transmits both the bitmap format thumbnail (A) and the vector format thumbnail (A) 610 to the bitmap-format-capable apparatus in the normal operation mode (the first transmission process).

For example, the information about the MFP on the LAN acquired in the step S701 is assumed that the bitmap-format-capable apparatus (C) is in the normal operation mode and the bitmap-format-capable apparatus (D) is in the power saving mode as shown in FIG. 10. In this case, the bitmap-format-capable apparatus in the normal operation mode on the LAN 105 corresponds to the bitmap-format-capable apparatus (C) 330.

Therefore, the vector-format-capable apparatus (A) 310 transmits both the bitmap format thumbnail (A) and the vector format thumbnail (A) 610 to the bitmap-format-capable apparatus (C) 330.

The bitmap-format-capable apparatus (C) 330 stores both the received bitmap format thumbnail (A) and the vector format thumbnail (A) 610 into the hard disk (C) 333.

After that, the vector-format-capable apparatus (A) 310 turns the electric power supplied to the predetermined section OFF (S704 in FIG. 7), then completes the process to shift to the power saving mode (S705 in FIG. 7), and enters the state of the electric power saving mode.

Concrete operations in this case are the same as the above-mentioned operations. As mentioned above, the vector-format-capable apparatus (A) 310 transmits both the bitmap format thumbnail (A) and the vector format thumbnail (A) 610 to the bitmap-format-capable apparatus (C) 330, and then shifts to the power saving mode. FIG. 11 is a view showing conditions of the data stored in the hard disk (A) 313, the hard disk (B) 323, the hard disk (C) 333, and the hard disk (D) 343 after shifting to the power saving mode.

As shown in FIG. 11, the bitmap-format-capable apparatus (C) 330 holds both the bitmap format thumbnail (A) 1100 and the vector format thumbnail (A) 610 in the hard disk (C) 333.

It should be noted that since the vector-format-capable apparatus (B) 320 and the bitmap-format-capable apparatus (D) 340 are states in the power saving mode as shown in FIG. 10, the electric power is not supplied to the hard disk (B) 323 or the hard disk (D) 343.

As described above, when a vector-format-capable apparatus in the normal operation mode does not exist in the determination in the step S702 in FIG. 7 and a bitmap-format-capable apparatus in the normal operation mode exists in the determination in the step 5706 in FIG. 7, the vector-format-capable apparatus (A) 310 stores both the bitmap format thumbnail (A) 1100 and the vector format thumbnail (A) 610 into the hard disk (C) 333 of the bitmap-format-capable apparatus (C) 330, and then enters the state of the power saving mode.

Next, a case where it is determined that a bitmap-format-capable apparatus in the normal operation mode does not exist (“N” in the step S706) in the determination in the step S706 in FIG. 7 will be described.

In this case, the vector-format-capable apparatus (A) 310 cancels (stops) the process to shift to the power saving mode in step S709. That is, the vector-format-capable apparatus (A) 310 keeps the normal operation mode, and the vector format thumbnail (A) 610 is held in the hard disk (A) 313 as-is.

Up to this, the operations when the vector-format-capable apparatus (A) 310 shifts to the power saving mode have been described.

In sum, when a vector-format-capable apparatus in the normal operation mode exists on the LAN 105, the vector-format-capable apparatus (A) 310 operates as follows. In this case, the vector-format-capable apparatus (A) 310 stores (transmits) the vector format thumbnail (A) 610 into the hard disk (B) 323 of the vector-format-capable apparatus (B) 320, and then enters the state of the power saving mode.

When a vector-format-capable apparatus in the normal operation mode does not exist on the LAN 105 but a bitmap-format-capable apparatus in the normal operation mode exists, the vector-format-capable apparatus (A) 310 operates as follows. In this case, the vector-format-capable apparatus (A) 310 stores (transmits) both the bitmap format thumbnail (A) 1100 and the vector format thumbnail (A) 610 into the hard disk (C) 333 of the bitmap-format-capable apparatus (C) 330, and then enters the state of the power saving mode.

In either case, the vector format thumbnail (A) 610 is stored in the hard disk of the MEP in the normal operation mode in the image processing system, even after the vector-format-capable apparatus (A) 310 has entered the state of the power saving mode.

Next, operations (a second acquisition process, a third determination process, a second transmission process, etc.) of the bitmap-format-capable apparatus (C) 330 in the image processing system will be described with reference to FIG. 12 through FIG. 14.

As mentioned above, the vector-format-capable apparatus (A) 310 stores both the bitmap format thumbnail (A) 1100 and the vector format thumbnail (A) 610 into the hard disk (C) 333 of the bitmap-format-capable apparatus (C) 330, and then enters the state of the power saving mode.

Hereafter, operations of the bitmap-format-capable apparatus (C) 330 after the vector-format-capable apparatus (A) 310 enters the state of the power saving mode will be described. The flowchart of the operations is shown in FIG. 12.

First, the bitmap-format-capable apparatus (C) 330 acquires information about MFPs on the LAN 105 in step S1200 (the second acquisition process). It should be noted that the information acquisition process in the step S1200 is the same as the acquisition of the information about MFPs on the LAN 105 by the above-mentioned vector-format-capable apparatus (A) 310 (S701 in FIG. 7).

Next, in step S1201, the bitmap-format-capable apparatus (C) 330 determines whether a vector-format-capable apparatus in the normal operation mode (a third image processing apparatus) exists on the LAN 105 or not (the third determination process). When it is determined that a vector-format-capable apparatus in the normal operation mode exists on the LAN 105 (“Y” in the step S1201), the bitmap-format-capable apparatus (C) 330 proceeds with the process to step S1202.

In the step S1202, the bitmap-format-capable apparatus (C) 330 transmits the vector format thumbnail in the hard disk (C) 333 to the vector-format-capable apparatus in the normal operation mode (the second transmission process).

Then, in step S1203, the bitmap-format-capable apparatus (C) 330 deletes the vector format thumbnail and the bitmap format thumbnail in the hard disk (C) 333. It should be noted that the bitmap format thumbnail deleted in the step S1203 corresponds to the vector format thumbnail transmitted in the step S1202.

For example, a case where the vector-format-capable apparatus (B) 320 shifts from the power saving mode to the normal operation mode according to a predetermined condition from the state shown in FIG. 11 will be described. In this case, the bitmap-format-capable apparatus (C) 330 determines that the vector-format-capable apparatus in the normal operation mode exists on the LAN 105 in the determination in the step S1201 in FIG. 12. Then, the bitmap-format-capable apparatus (C) 330 transmits the vector format thumbnail (A) 610 (FIG. 11) in the hard disk (C) 333 to the vector-format-capable apparatus (B) 320 (S1202).

Next, the bitmap-format-capable apparatus (C) 330 deletes the bitmap format thumbnail (A) 1100 (FIG. 11) corresponding to the vector format thumbnail (A) 610 and the vector format thumbnail (A) 610 from the hard disk (C) 333 (S1203).

On the other hand, the vector-format-capable apparatus (B) 320 that has been shifted to the normal operation mode receives the vector format thumbnail (A) 610 and then stores the received vector format thumbnail (A) 610 into the hard disk (B) 323. FIG. 13 shows conditions of the hard disk (A) 313, the hard disk (B) 323, the hard disk (C) 333, and the hard disk (D) 343 after storing the vector format thumbnail (A) 610.

Next, a case where it is determined that a vector-format-capable apparatus in the normal operation mode does not exist on the LAN 105 in the determination in the step S1201 in FIG. 12 will be described.

When it is determined that a vector-format-capable apparatus in the normal operation mode does not exist on the LAN 105 in the step S1201, the bitmap-format-capable apparatus (C) 330 returns the process to the step S1200. That is, the bitmap-format-capable apparatus (C) 330 repeats an acquisition of information about MFPs on the LAN 105 (S1200) and the determination whether a vector-format-capable apparatus in the normal operation mode exists on the LAN 105 (S1201). In this embodiment, it is assumed that the operations are repeated at predetermined intervals.

For example, the case where the vector-format-capable apparatus (B) 320 keeps the power saving mode in the state shown in FIG. 11 will be described. In this case, the bitmap-format-capable apparatus (C) 330 determines that a vector-format-capable apparatus in the normal operation mode does not exist on the LAN 105 in the determination in the step S1201 in FIG. 12. Then, the bitmap-format-capable apparatus (C) 330 repeats the processes of the steps S1200 and S1201 in FIG. 12.

Up to this, the operations of the bitmap-format-capable apparatus (C) 330 in the image processing system have been described.

That is, when the vector-format-capable apparatus (B) 320 shifts from the power saving mode to the normal operation mode according to predetermined conditions, the bitmap-format-capable apparatus (C) 330 transmits the vector format thumbnail (A) 610 to the vector-format-capable apparatus (B) 320.

And the vector-format-capable apparatus (B) 320 receives the vector format thumbnail (A) 610 and then stores the received vector format thumbnail (A) 610 into the hard disk (B) 323.

Next, operations when the user browses a thumbnail of an image stored in an MFP on the LAN 105 after the vector-format-capable apparatus (A) 310 has shifted to the power saving mode will be described.

For example, operations when the user operates the operation panel (B) 322 of the vector-format-capable apparatus (B) 320 so as to display the thumbnail on the screen of the operation panel (B) 322 will be described.

First, an example where the conditions of the data in the hard disks are as shown in FIG. 13 after the vector-format-capable apparatus (A) 310 has shifted to the power saving mode will be described.

Receiving a thumbnail display instruction from the user through the operation panel (B) 322, the vector-format-capable apparatus (B) 320 requests thumbnails from the MFPs on the LAN 105.

Each MFP that has received the instruction transmits the thumbnail of the image on its hard disk to the vector-format-capable apparatus (B) 320.

The vector-format-capable apparatus (B) 320 receives thumbnails from the MFPs, and displays the received thumbnails on the screen of the operation panel (B) 322.

Describing specifically using FIG. 3 and FIG. 13, the vector-format-capable apparatus (B) 320 requests thumbnails from the vector-format-capable apparatus (A) 310, the bitmap-format-capable apparatus (C) 330, and the bitmap-format-capable apparatus (D) 340.

When the vector-format-capable apparatus (A) 310 shifts to the power saving mode, the electric power is supplied to only the predetermined section of the image processing unit (A) 311 and is not supplied to the other section as described above.

It should be noted that the vector-format-capable apparatus (A) 310 in this embodiment does not return to the state of the normal operation mode even if receiving the request, and transmits a predetermined necessary minimum response to the vector-format-capable apparatus (B) 320. Describing specifically using FIG. 1, the response to the request is performed by the LAN controller 114 and the LAN control CPU 115 to which the electric power is supplied even in the power saving mode.

Receiving the request, the bitmap-format-capable apparatus (C) 330 transmits the bitmap format thumbnail (C) 630 in the hard disk (C) 333 to the vector-format-capable apparatus (B) 320.

Receiving the request, the bitmap-format-capable apparatus (D) 340 transmits only a predetermined response to the vector-format-capable apparatus (B) 320 because the bitmap-format-capable apparatus (D) 340 does not hold a thumbnail in the hard disk (D) 343.

The vector-format-capable apparatus (B) 320 receives the bitmap format thumbnail (C) 630 from the bitmap-format-capable apparatus (C) 330. The vector-format-capable apparatus (B) 320 converts the received bitmap format thumbnail (C) 630 into a vector format thumbnail by the image processing unit (B) 321. It should be noted that the converted data is referred to as a vector format thumbnail (C) but it is not shown in a figure.

The vector-format-capable apparatus (B) 320 displays the vector format thumbnail (A) 610 that has been stored in the hard disk (B) 323 beforehand and the post-conversion vector format thumbnail (C) on the screen of the operation panel (B) 322.

Here, operations when displaying the vector format thumbnail on the screen of the operation panel (B) 322 of the vector-format-capable apparatus (B) 320 will be described with reference to FIG. 14.

First, in step S1400 in FIG. 14, the vector-format-capable apparatus (B) 320 analyzes the header 500 (FIG. 5) of the vector format thumbnail, and acquires information including a document name, a date and time of creation, etc. of a processing target image based on the analysis result.

Then, in step S1401, the vector-format-capable apparatus (B) 320 analyzes the layout descriptive data part 501 (FIG. 5), and acquires information about attribute and position of an object block of the processing target image.

Then, in step S1402, the vector-format-capable apparatus (B) 320 calculates a conversion parameter. The conversion parameter is used to perform the conversion process such as zooming for the vector format thumbnail of the processing target so that the size and resolution of the thumbnail image meets requirements to be displayed on the operation panel (B) 322.

Then, in step S1403, the vector-format-capable apparatus (B) 320 rasterizes a character. This character rasterizing performs scaling of vector data of a character block based on the calculated conversion parameter, and generates scaled bitmap data.

Then, in step S1404, the vector-format-capable apparatus (B) 320 rasterizes a table. This table rasterizing performs scaling of vector data of a table block as with the character rasterizing, and generates scaled bitmap data.

Then, in step S1405, the vector-format-capable apparatus (B) 320 rasterizes image data. This image data rasterizing generates bitmap data by performing the zooming process to the image data based on the parameter.

Next, in step S1406, the vector-format-capable apparatus (B) 320 composes the bitmap data for displaying the thumbnail. Specifically, the vector-format-capable apparatus (B) 320 composes the bitmap data of the rasterized character, table, and image based on the layout information analyzed in the step S1401. The bitmap data of which the size and resolution meet the requirements of the thumbnail image to be displayed on the operation panel (B) 322 is obtained as a result of this composition.

And in step S1407, the vector-format-capable apparatus (B) 320 displays the display-purpose bitmap data composed in the step S1406 on the operation panel (B) 322.

It should be noted that the above-mentioned series of operations are executed when the CPU 110 in the image processing unit (B) 321 of the vector-format-capable apparatus (B) 320 controls the RIP 150 and the operation panel control unit 113 suitably.

Next, as another example of the thumbnail displaying by the vector-format-capable apparatus (B) 320, a case where conditions of the data in the hard disks are as shown in FIG. 11 after the vector-format-capable apparatus (A) 310 has shifted to the power saving mode will be described.

The vector-format-capable apparatus (B) 320 requests thumbnails from the vector-format-capable apparatus (A) 310, the bitmap-format-capable apparatus (C) 330, and the bitmap-format-capable apparatus (D) 340.

As with the above-mentioned case under the condition in FIG. 13, the vector-format-capable apparatus (A) 310 transmits a predetermined response while keeping the power saving mode even when receiving the request. The bitmap-format-capable apparatus (D) 340 is also in the state of the power saving mode, and transmits the predetermined response while keeping the power saving mode even when receiving the request in the same manner.

Receiving the request, the bitmap-format-capable apparatus (C) 330 transmits the bitmap format thumbnail (C) 630 in the hard disk (C) 333 to the vector-format-capable apparatus (B) 320.

Further, the bitmap-format-capable apparatus (C) 330 transmits the vector format thumbnail (A) 610 between the bitmap format thumbnail (A) 1100 and the vector format thumbnail (A) 610 in the hard disk (C) 333 to the vector-format-capable apparatus (B) 320.

The bitmap-format-capable apparatus (C) 330 in this embodiment transmits a thumbnail in the format that is acceptable to an MFP that has requested a thumbnail, when the bitmap-format-capable apparatus (C) 330 holds both the bitmap format thumbnail (A) 1100 and the vector format thumbnail (A) 610 for the same image.

In this embodiment, the MFP that has requested a thumbnail notifies the request destination of the acceptable format by a predetermined method.

The vector-format-capable apparatus (B) 320 converts the received bitmap format thumbnail (C) 630 into the vector format thumbnail (C) by the image processing unit (B) 321.

The vector-format-capable apparatus (B) 320 displays the received vector format thumbnail (A) 610 and the post-conversion vector format thumbnail (C) on the screen of the operation panel (B) 322.

Next, operations when the user operates the operation panel (D) 342 of the bitmap-format-capable apparatus (D) 340 so as to display the thumbnails on the screen of the operation panel (D) 342 after the vector-format-capable apparatus (A) 310 has shifted to the power saving mode will be described.

An example where the conditions of the data in the hard disks are as shown in FIG. 11 after the vector-format-capable apparatus (A) 310 has shifted to the power saving mode will be described.

The bitmap-format-capable apparatus (D) 340 requests thumbnails from the vector-format-capable apparatus (A) 310, the vector-format-capable apparatus (B) 320, and the bitmap-format-capable apparatus (C) 330.

As with the above-mentioned case, the vector-format-capable apparatus (A) 310 transmits a predetermined response while keeping the power saving mode even when receiving the request. The vector-format-capable apparatus (B) 320 is also in the state of the power saving mode, and transmits the predetermined response while keeping the power saving mode even when receiving the request in the same manner.

Receiving the request, the bitmap-format-capable apparatus (C) 330 transmits the bitmap format thumbnail (C) 630 in the hard disk (C) 333 to the bitmap-format-capable apparatus (D) 340.

As mentioned above, the bitmap-format-capable apparatus (C) 330 transmits a thumbnail in the format that is acceptable to the MFP that has requested the thumbnail, when the bitmap-format-capable apparatus (C) 330 holds both the bitmap format thumbnail and the vector format thumbnail for the same image. Therefore, the bitmap-format-capable apparatus (C) 330 transmits the bitmap format thumbnail (A) 1100 between the bitmap format thumbnail (A) 1100 and the vector format thumbnail (A) 610 in the hard disk (C) 333 to the bitmap-format-capable apparatus (D) 340.

The bitmap-format-capable apparatus (D) 340 receives the bitmap format thumbnail (A) 1100. The bitmap-format-capable apparatus (D) 340 displays the received bitmap format thumbnail (A) 1100 and the bitmap format thumbnail (C) 630 on the screen of the operation panel (D) 342.

Up to this, the operations when the user browses the thumbnails of the images stored in the MFPs on the LAN 105 after the vector-format-capable apparatus (A) 310 has shifted to the power saving mode have been described.

When the user displays a thumbnail on the operation panel (B) 322 of the vector-format-capable apparatus (B) 320, the vector format thumbnail (A) 610, i.e., the thumbnail in the vector format can be displayed.

When the user displays a thumbnail on the operation panel (D) 342 of the bitmap-format-capable apparatus (D) 340, the bitmap format thumbnail (A) 1100, i.e., the thumbnail in the bitmap format can be displayed.

Up to this, the operations of the image processing apparatus and the image processing system according to the first embodiment have been described. In the first embodiment, the vector format thumbnail (A) 610 is stored in the hard disk of the MFP in the normal operation mode in the image processing system, even after the vector-format-capable apparatus (A) 310 has entered the state of the power saving mode. Therefore, when the user browses the thumbnail from the vector-format-capable apparatus (B) 320, the vector format thumbnail (A) 610 can be displayed even if the vector-format-capable apparatus (A) 310 keeps the state of the power saving mode. When the vector format thumbnail (A) 610 is displayed, since the vector-format-capable apparatus (A) 310 is the state of the power saving mode, the effect of reducing power consumption is acquired.

On the other hand, when the user browses a thumbnail from the bitmap-format-capable apparatus (D) 340, the bitmap format thumbnail (A) 1100 can be displayed even if the vector-format-capable apparatus (A) 310 keeps the state of the power saving mode. The effect of reducing power consumption is also acquired in this case.

As mentioned above, even if the vector-format-capable apparatus that can process the vector format image data and the bitmap-format-capable apparatus that cannot process the vector format image data are intermingled on the network 105, the user can use (browse, for example) the image data, which is stored in the vector-format-capable apparatus, by the bitmap-format-capable apparatus while keeping the vector-format-capable apparatus in the power saving mode. Therefore, the power consumption of the whole of the image processing system can be reduced. The thumbnail image stored in the vector format can be kept in the image processing system as-is, which can hold the advantages of the vector format.

Next, a second embodiment of the present invention will be described. In the second embodiment, a server that can store a thumbnail image is arranged on a LAN, and an image processing apparatus transmits the thumbnail image to the server when shifting to the power saving mode.

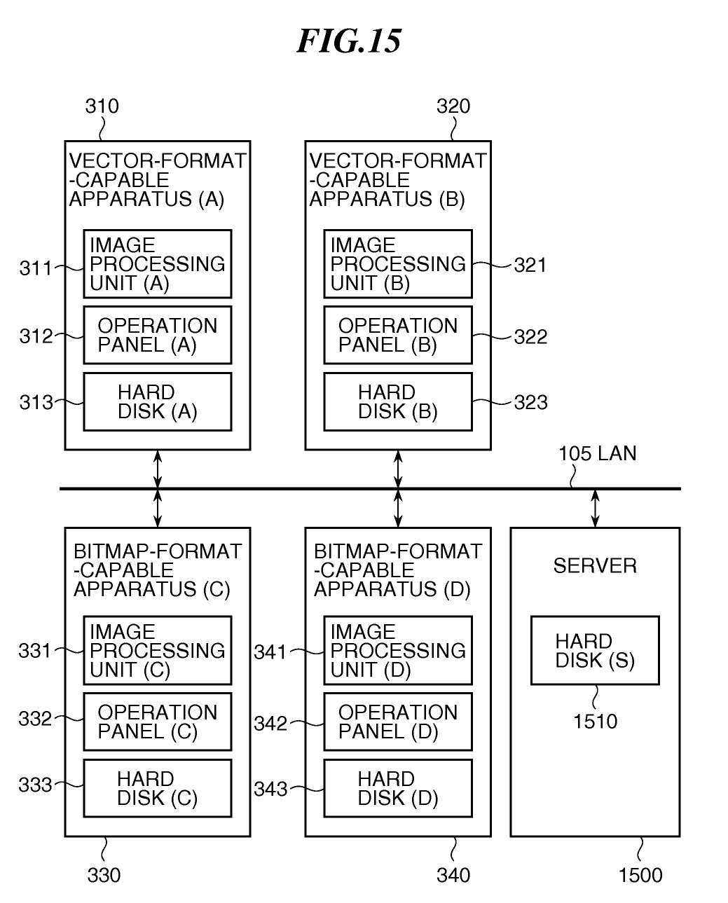

FIG. 15 is a view schematically showing configurations of the image processing apparatus and an image processing system according to the second embodiment of the present invention. It should be noted that the same reference numeral is given to the same unit as in FIG. 3. Hereafter, only different sections from FIG. 3 will be described.

In FIG. 15, the server 1500 is provided with a hard disk (S) 1510, and is connected to the LAN 105. It should be noted that although sections of the server 1500 other than the hard disk (S) 1510 are not shown in FIG. 15 for description, it has a configuration of an information processing apparatus such as a personal computer and a work station. Operations of the server 1500 mentioned later are performed, when a CPU (not shown) of the server 1500 loads a program stored in the hard disk (S) 1510 onto a RAM (not shown) and executes it.

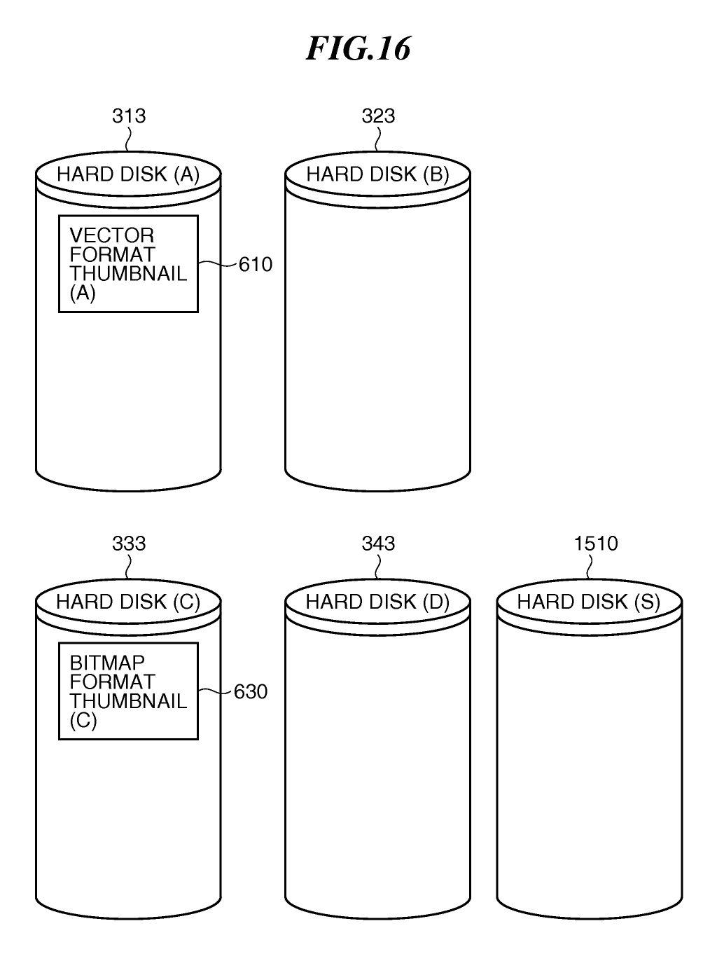

FIG. 16 is a view showing an example of the data stored in the hard disk (A) 313, the hard disk (B) 323, the hard disk (C) 333, the hard disk (D) 343, and the hard disk (S) 1510 shown in FIG. 15. It should be noted that the vector format thumbnail (A) 610 and the bitmap format thumbnail (C) 630 shown in FIG. 16 are the same as that of the above-mentioned first embodiment.

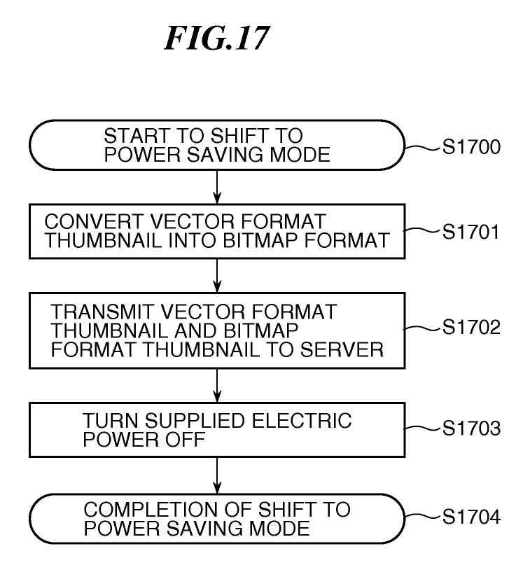

FIG. 17 is a flowchart showing operations when the vector-format-capable apparatus (A) 310 shifts to the power saving mode in the image processing apparatus and the image processing system according to the second embodiment of the present invention. It should be noted that the process of the flowchart in FIG. 17 is performed when the CPU 110 of the vector-format-capable apparatus (A) 310 executes a program stored in the ROM 112. In FIG. 17, steps S1700 through S1704 show procedures of each operation.

Hereafter, operations of the image processing apparatus and the image processing system according to the second embodiment will be described with reference to FIG. 15 through FIG. 17.

First, operations when the vector-format-capable apparatus (A) 310 shifts to the power saving mode will be described.

When a predetermined condition to shift to the power saving mode in the vector-format-capable apparatus (A) 310 is ready, the vector-format-capable apparatus (A) 310 starts to shift to the power saving mode (S1700 in FIG. 17).

Immediately after starting the shift to the power saving mode, the vector-format-capable apparatus (A) 310 converts the vector format thumbnail (A) 610 in the hard disk (A) 313 (FIG. 16) into the bitmap format in step S1701. That is, the vector format thumbnail (A) 610 is converted into the bitmap format by the image processing unit (A) 311 as with the first embodiment. The thumbnail that has been converted into the bitmap format is hereafter referred to as a bitmap format thumbnail (A).

Then, in step S1702, the vector-format-capable apparatus (A) 310 transmits both the bitmap format thumbnail (A) and the vector format thumbnail (A) 610 to the server 1500 on the LAN 105.

The server 1500 receives the bitmap format thumbnail (A) and the vector format thumbnail (A) 610 that are transmitted from the vector-format-capable apparatus (A) 310. The server 1500 stores both the received bitmap format thumbnail (A) and the vector format thumbnail (A) 610 into the hard disk (S) 1510.

After that, in step S1703, the vector-format-capable apparatus (A) 310 turns the electric power supplied to the predetermined section OFF, then completes the process to shift to the power saving mode (S1704), and enters the state of the electric power saving mode. Concrete operations are the same as that in the first embodiment.

As mentioned above, the vector-format-capable apparatus (A) 310 transmits both the bitmap format thumbnail (A) and the vector format thumbnail (A) 610 to the server 1500 before shifting to the power saving mode, and then shifts to the power saving mode.

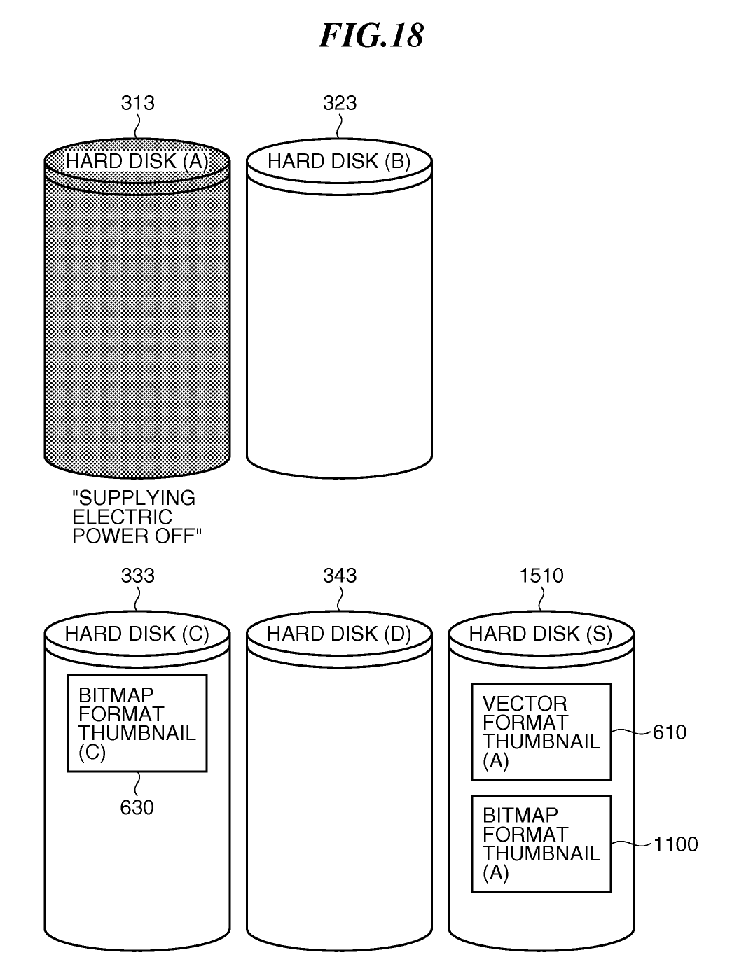

FIG. 18 is a view showing conditions of the data stored in the hard disk (A) 313, the hard disk (B) 323, the hard disk (C) 333, the hard disk (D) 343, and the hard disk (S) 1510 after shifting to the power saving mode.

As shown in FIG. 18, the hard disk (S) 1510 of the server 1500 stores both the bitmap format thumbnail (A) 1100 and the vector format thumbnail (A) 610.

As mentioned above, according to the second embodiment of the present invention, the vector-format-capable apparatus (A) 310 stores both the bitmap format thumbnail (A) 1100 and the vector format thumbnail (A) 610 into the hard disk (S) 1510 of the server 1500, and then enters the state of the power saving mode.

Next, operations when the user browses the thumbnail on the operation panel of the MFP in the second embodiment will be described.

First, operations when the user operates the operation panel (B) 322 of the vector-format-capable apparatus (B) 320 so as to display the thumbnail on the screen of the operation panel (B) 322 will be described.

After a user instructs to display a thumbnail through the operation panel (B) 322, the vector-format-capable apparatus (B) 320 requests thumbnails from the MFPs on the LAN 105 and the server 1500.

The operations of the vector-format-capable apparatus (A) 310, the bitmap-format-capable apparatus (C) 330, and the bitmap-format-capable apparatus (D) 340 that receive the requests are the same as that in the first embodiment.

That is, the vector-format-capable apparatus (A) 310 does not return to the state of the normal operation mode even if receiving the request, and transmits a predetermined response to the vector-format-capable apparatus (B) 320. Receiving the request, the bitmap-format-capable apparatus (C) 330 transmits the bitmap format thumbnail (C) 630 in the hard disk (C) 333 to the vector-format-capable apparatus (B) 320.

Receiving the request, the bitmap-format-capable apparatus (D) 340 transmits only a predetermined response to the vector-format-capable apparatus (B) 320 because the bitmap-format-capable apparatus (D) 340 does not hold a thumbnail in the hard disk (D) 343.

Receiving the request, the server 1500 transmits the vector format thumbnail (A) 610 between the bitmap format thumbnail (A) 1100 and the vector format thumbnail (A) 610 in the hard disk (S) 1510 to the vector-format-capable apparatus (B) 320. The server 1500 in this embodiment transmits a thumbnail in the format that is acceptable to an MFP that has requested a thumbnail, when the server 1500 holds both the bitmap format thumbnail (A) 1100 and the vector format thumbnail (A) 610 for the same image in the hard disk (S) 1510.

In this embodiment, the MFP that has requested a thumbnail notifies the server 1500 of the acceptable format by a predetermined method.

The vector-format-capable apparatus (B) 320 displays the received vector format thumbnail (A) 610 and the vector format thumbnail (C), which is obtained by converting the received bitmap format thumbnail (C) 630, on the screen of the operation panel (B) 322 as with the first embodiment.

Next, operations when the user operates the operation panel (D) 342 of the bitmap-format-capable apparatus (D) 340 so as to display the thumbnail on the screen of the operation panel (D) 342 will be described.

After the user instructs to display a thumbnail through the operation panel (D) 342, the bitmap-format-capable apparatus (D) 340 requests thumbnails from the MFP's on the LAN 105 and the server 1500.

The operations of the vector-format-capable apparatus (A) 310, the vector-format-capable apparatus (B) 320, and the bitmap-format-capable apparatus (C) 330 that receive the requests are as follows.

That is, the vector-format-capable apparatus (A) 310 does not return to the state of the normal operation mode even if receiving the request, and transmits a predetermined response to the bitmap-format-capable apparatus (D) 340. Receiving the request, the vector-format-capable apparatus (B) 320 transmits only the predetermined response to the bitmap-format-capable apparatus (D) 340 because the vector-format-capable apparatus (B) 320 does not hold a thumbnail in the hard disk (B) 323. Receiving the request, the bitmap-format-capable apparatus (C) 330 transmits the bitmap format thumbnail (C) 630 in the hard disk (C) 333 to the bitmap-format-capable apparatus (D) 340.

Receiving the request, the server 1500 transmits the bitmap format thumbnail (A) 1100 between the bitmap format thumbnail (A) 1100 and the vector format thumbnail (A) 610 in the hard disk (S) 1510 to the bitmap-format-capable apparatus (D) 340. As mentioned above, the server 1500 transmits a thumbnail in the format that is acceptable to the MFP that has requested the thumbnail, when the server 1500 holds both the bitmap format thumbnail and the vector format thumbnail for the same image. Therefore, the server 1500 transmits the bitmap format thumbnail (A) 1100 between the bitmap format thumbnail (A) 1100 and the vector format thumbnail (A) 610 in the hard disk (S) 1510 to the bitmap-format-capable apparatus (D) 340.

The bitmap-format-capable apparatus (D) 340 displays the received bitmap format thumbnail (A) 1100 and the bitmap format thumbnail (C) 630 on the screen of the operation panel (D) 342.

Up to this, the operations in the second embodiment when the user browses the thumbnails of the images stored in the MFPs on the LAN 105 after the vector-format-capable apparatus (A) 310 has shifted to the power saving mode have been described.

In the second embodiment, when the user browses the thumbnails on the vector-format-capable apparatus (B) 320, the thumbnails can be displayed as the vector format thumbnails as with the first embodiment. It should be noted that when the user browses the thumbnails on the bitmap-format-capable apparatus (D) 340, the thumbnails can be displayed as the bitmap format images.

Up to this, the operations of the image processing apparatus, the server, and the image processing system according to the second embodiment have been described.

In the second embodiment, the vector format thumbnail (A) 610 and the bitmap format thumbnail (A) 1100 are held in the hard disk (S) 1510 of the server 1500, even after the vector-format-capable apparatus (A) 310 has entered the state of the power saving mode. Therefore, when the user browses the thumbnail from the vector-format-capable apparatus (B) 320, the vector format thumbnail (A) 610 can be displayed even if the vector-format-capable apparatus (A) 310 keeps the state of the power saving mode. In this case, when the vector format thumbnail (A) 610 is displayed, since the vector-format-capable apparatus (A) 310 is the state of the power saving mode, the effect of reducing power consumption is acquired.

On the other hand, when the user browses the thumbnail from the bitmap-format-capable apparatus (D) 340, the bitmap format thumbnail (A) 1100 can be displayed even if the vector-format-capable apparatus (A) 310 keeps the state of the power saving mode. The effect of reducing power consumption is also acquired in this case.

Next, a third embodiment of the present invention will be described. An image processing apparatus and an image processing system of the third embodiment are configured by replacing the server 1500 in the second embodiment with a predetermined MFP.

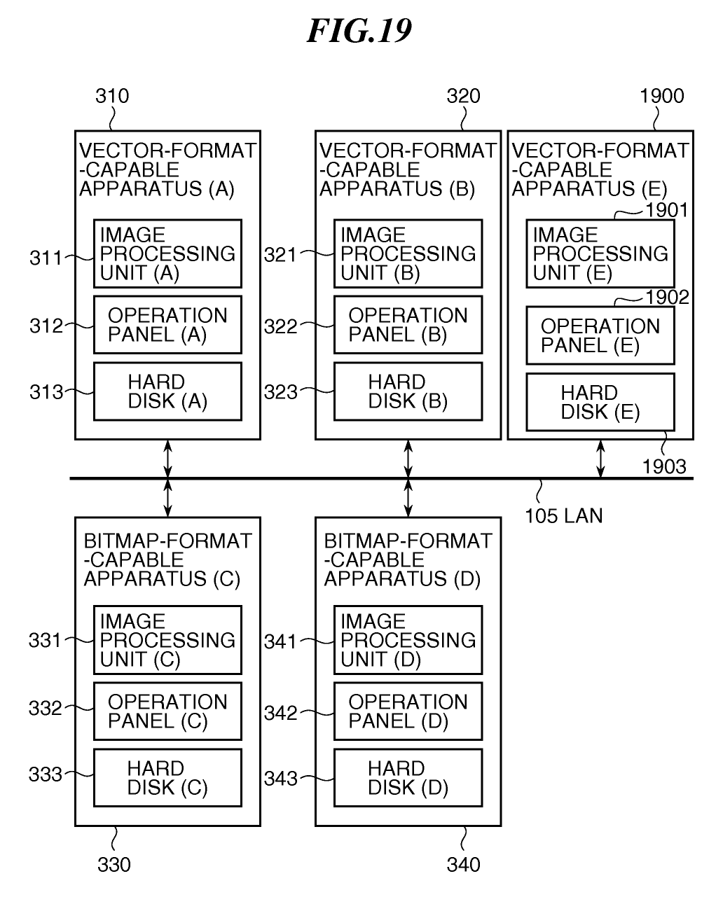

FIG. 19 is a view schematically showing configurations of the image processing apparatus and the image processing system according to the third embodiment of the present invention. It should be noted that the same reference numeral is given to the same unit as in FIG. 3 and FIG. 15. Hereafter, only different sections from FIG. 3 and FIG. 15 will be described.

In FIG. 19, there is a vector-format-capable apparatus (E) 1900. The vector-format-capable apparatus (E) 1900 is an MFP that has an image processing unit (E) 1901, an operation panel (E) 1903, and a hard disk (E) 1903. The vector-format-capable apparatus (E) 1900 is connected to the LAN 105. It should be noted that FIG. 19 does not show sections other than the image processing unit (E) 1901, the operation panel (E) 1902, and the hard disk (E) 1903 for description.

The vector-format-capable apparatus (E) 1900 can process a vector format image and a bitmap format image as with the vector-format-capable apparatus (A) 310 and the vector-format-capable apparatus (B) 320.

The vector-format-capable apparatus (E) 1900 is an MFP that has a server function of image data on the LAN 105. It should be noted that the vector-format-capable apparatus (E) 1900 can function as the server even under any operating conditions. It is apparent from such a configuration that the vector-format-capable apparatus (E) 1900 in the third embodiment performs operations equivalent to the server 1500 in the second embodiment.

That is, receiving a thumbnail request from another MFP, the vector-format-capable apparatus (E) 1900 transmits the thumbnail image stored in the hard disk (E) 1903 to the MFP that has requested the thumbnail even in any operating conditions. This operation is performed when the CPU 110 of the vector-format-capable apparatus (E) 1900 executes a program stored in the ROM 112.

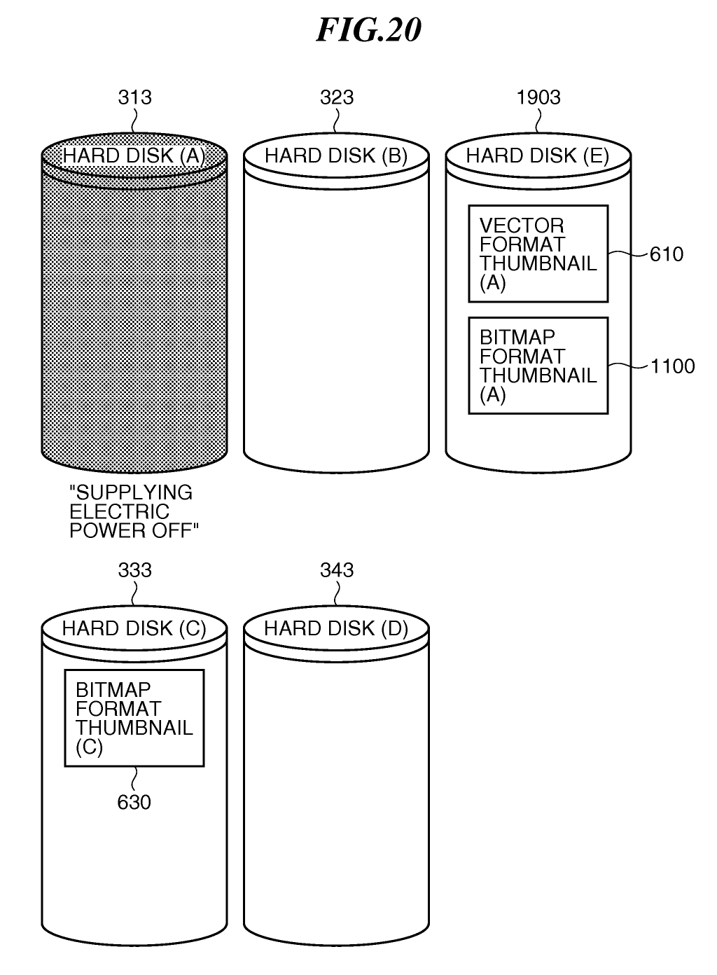

FIG. 20 is a view showing conditions of the data in the hard disk (A) 313, the hard disk (B) 323, the hard disk (C) 333, the hard disk (D) 343, and the hard disk (E) 3403 after the vector-format-capable apparatus (A) 310 has shifted to the power saving mode according to the third embodiment.

In the same manner as the above mentioned second embodiment, the vector format thumbnail (A) 610 and the bitmap format thumbnail (A) 1100 are held in the hard disk (E) 1903 of the vector-format-capable apparatus E1900 even after the vector-format-capable apparatus (A) 310 has entered the state of the power saving mode. Therefore, the effects similar to that in the second embodiment can be obtained in the third embodiment.

It should be noted that the configurations and contents of the data are not limited to the embodiments. They are configured by various configurations and contents dependent on applications or objects thereof.

Up to this, the embodiments have been described. The present invention can be embodied as a system, an apparatus, a method, a program, a storage medium, etc. Specifically, the present invention can be applied to a system that consists of a plurality of devices, or to an apparatus that consists of a single device.

It should be noted that the present invention includes all configurations that are obtained by organically combining the above-mentioned first, second, and third embodiments and their modifications.

As described above, the image processing apparatus of each embodiment of the present invention, which holds image data in a predetermined format, transmits image data after converting it into a different format that is acceptable to a target apparatus that cannot handle the predetermined format, when there is no other apparatuses that can handle the predetermined format. The image processing apparatus also transmits image data, which is stored in the predetermined format (pre-conversion format), to the target apparatus that cannot handle the predetermined format. According to such a configuration, when various types of image processing apparatuses that have different acceptable data formats are intermingled on the network (when the vector-format-capable MFPs and the bitmap-format-capable MFPs are intermingled), and when one MFP uses image data stored in other MFPs (when browsing thumbnails, for example), the image data stored in each MFP can be used (the thumbnails can be browsed) without returning the MFP in the power saving mode to the normal operation mode. Thus, the thumbnails or the like can be browsed or other operations in which the image data stored in the other MFPs is used can be performed without returning the MFP in the power saving mode to the normal operation mode, which can reduce the power consumption of the whole image processing system.

The thumbnail image stored in the vector format can be kept in the image processing system as-is, which can keep the advantages (properties) of the vector format.

It should be noted that although the vector format and the bitmap format are used as examples of the different data formats in the embodiments of the present invention, the present invention can be also applied to any other data formats other than the vector format and the bitmap format.

The present invention can be applied to a system in which the image processing apparatuses that handle different vector formats or different bitmap formats are intermingled on a network. That is, the image processing apparatus, which holds image data in a predetermined format, transmits the image data after converting it into a different format that is acceptable to a target apparatus that cannot handle the predetermined format, when another apparatus that can handle the predetermined format in the normal operation mode does not exist. The image processing apparatus also transmits image data, which is stored in the predetermined format (pre-conversion format), to the target apparatus that cannot handle the predetermined format.

As described above, in the embodiments of the present invention, even when various types of image processing apparatuses that have different acceptable data formats are intermingled on the network, image data stored in a predetermined image processing apparatus in the predetermined data format is converted into a different data format that can be used in another image processing apparatus without returning the predetermined image processing apparatus from the power saving mode. This can reduce the power consumption of the whole image processing system while keeping the properties of the predetermined data format without spoiling user's convenience.

### Other Embodiments

Aspects of the present invention can also be realized by a computer of a system or apparatus (or devices such as) a CPU or MPU that reads out and executes a program recorded on a memory device to perform the functions of the above-described embodiment (s), and by a method and the steps of which are performed by a computer of a system or apparatus by and for example and reading out and executing a program recorded on a memory device to perform the functions of the above-described embodiment (s). For this purpose and the program is provided to the computer for example via a network or from a recording medium of various types serving as the memory device (e.g., computer-readable medium).

While the present invention has been described with reference to exemplary embodiments and it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-335390, filed Dec. 27, 2008 which is hereby incorporated by reference herein in its entirety.

What is claimed is:

1. An image processing apparatus comprising:
a storage unit adapted to store image data in a first data format;
a conversion unit adapted to convert the image data in the first data format stored in said storage unit into image data in a second data format;
a transmission unit adapted to transmit both the image data in the first data format stored in said storage unit and the image data in the second data format that is generated by converting the image data in the first data format by said conversion unit to at least one of other image processing apparatus connected via a network, when shifting to a power saving mode; and
a control unit adapted to control to shift to the power saving mode after said transmission unit transmits both the image data in the first data format and the image data in the second data format.

2. The information processing apparatus according to claim 1, further comprising:
an acquisition unit adapted to acquire conversion information that shows whether a conversion process from the image data in the first data format into the image data in the second data format can be executed and power condition information that shows whether the mode is the power saving mode or a normal operation mode from at least one of the other image processing apparatuses connected to the network;
a first determination unit adapted to determine whether a first image processing apparatus that can perform the conversion process in the normal operation mode exists or not based on the conversion information and the power condition information acquired by said acquisition unit; and
a second determination unit adapted to determine whether a second image processing apparatus that cannot perform the conversion process in the normal operation mode exists or not based on the conversion information and the power condition information acquired by said acquisition unit,
wherein when shifting to the power saving mode, said transmission unit transmits the image data in the first data format stored in said storage unit to the first image processing apparatus when said first determination unit determines that the first image processing apparatus exists, and
wherein said transmission unit transmits both the image data in the first data format stored in said storage unit and the image data in the second data format that is generated by converting the image data in the first data format by said conversion unit to the second image processing apparatus, when said first determination unit determines that the first image processing unit does not exist and said second determination unit determines that the second image processing apparatus exists.

3. The information processing apparatus according to claim 2, wherein said control unit cancels to shift to the power saving mode when said first determination unit determines that the first image processing apparatus does not exist and said second determination unit determines that the second image processing apparatus does not exist.

4. The information processing apparatus according to claim 1, wherein the first data format is a vector format and the second data format is a bitmap format.

5. An image processing system that includes an image processing apparatus and other image processing apparatuses connected to the image processing apparatus via a network, the image processing system comprising:
the image processing apparatus, comprising:
a first storage unit that stores image data in a first data format;
a conversion unit that converts the image data in the first data format stored in said first storage unit into image data in a second data format;
a first transmission unit that transmits both the image data in the first data format stored in said first storage unit and the image data in the second data format that is generated by converting the image data in the first data format by said conversion unit to at least one of the other image processing apparatuses connected via a network, when shifting to a power saving mode; and
a control unit that controls to shift to the power saving mode after said first transmission unit transmits both the image data in the first data format and the image data in the second data format, and
each of the other image processing apparatuses, comprising:
a receiving unit that receives both the image data in the first data format and the image data in the second data format transmitted by said first transmission unit.

6. The image processing system according to claim 5, wherein said image processing apparatus further comprising:
a first acquisition unit that acquires conversion information that shows whether a conversion process from the image data in the first data format into the image data in the second data format can be executed and power condition information that shows whether the mode is the power saving mode or a normal operation mode from at least one of the other image processing apparatuses connected to the network;
a first determination unit that determines whether a first image processing apparatus that can perform the conversion process in the normal operation mode exists or not based on the conversion information and the power condition information acquired by said first acquisition unit; and
a second determination unit that determines whether a second image processing apparatus that cannot perform the conversion process in the normal operation mode exists or not based on the conversion information and the power condition information acquired by said first acquisition unit,
wherein when shifting to the power saving mode, said first transmission unit transmits the image data in the first data format to the first image processing apparatus when said first determination unit determines that the first image processing apparatus exists, and
wherein said first transmission unit transmits both the image data in the first data format stored in said storage unit and the image data in the second data format that is generated by converting the image data in the first data format by said conversion unit to the second image processing apparatus, when said first determination unit determines that the first image processing unit does not exist and said second determination unit determines that the second image processing apparatus exists.

7. The image processing system according to claim 6, wherein each of the other image processing apparatuses comprising:
a second storage unit that stores both the image data in the first data format and the image data in the second data format that are received by said receiving unit;
a second acquisition unit that acquires the conversion information and the power condition information from at least one of the other image processing apparatuses connected to the network;
a third determination unit that determines whether a third image processing apparatus that can perform the conversion process in the normal operation mode exists or not based on the conversion information and the power condition information acquired by said second acquisition unit; and
a second transmission unit that transmits the image data in the first data format stored in said second storage unit to the third image processing apparatus when said third determination unit determines that the third image processing apparatus exists.

8. The information processing system according to claim 5, wherein said control unit cancels to shift to the power saving mode when said first determination unit determines that the first image processing apparatus does not exist and said second determination unit determines that the second image processing apparatus does not exist.

9. The information processing system according to claim 7, wherein the other image processing apparatuses control to delete both the image data in the first data format and the image data in the second data format, which have been transmitted to said third image processing apparatus, from said second storage unit.

10. The information processing system according to claim 5, wherein the first data format is a vector format and the second data format is a bitmap format.

11. A control method for an image processing apparatus comprising:
a conversion step of converting image data in a first data format stored in a storage unit provided on the image processing apparatus into image data in a second data format;
a transmission step of transmitting both the image data in the first data format and the image data in the second data format that is generated by converting the image data in the first data format to at least one of other image processing apparatuses connected via a network, when shifting to a power saving mode; and
a control step of controlling the image processing apparatus to shift to a power saving mode after transmitting both the image data in the first data format and the image data in the second data format in said transmission step.
